(19) United States
(12) Patent Application Publication
(10) Pub. No.: US 2018/0166886 A1
(43) Pub. Date: Jun. 14, 2018

(54) POWER FEEDING DEVICE, POWER FEEDING SYSTEM, AND CONTROL METHOD OF POWER FEEDING DEVICE

(71) Applicant: RENESAS ELECTRONICS CORPORATION, Tokyo (JP)

(72) Inventor: Kouji UETA, Tokyo (JP)

(21) Appl. No.: 15/815,319

(22) Filed: Nov. 16, 2017

(30) Foreign Application Priority Data
Dec. 14, 2016 (JP) 2016-242053

(51) Int. Cl. H02J 7/00; H01R 31/00; H01R 31/06

(52) U.S. Cl. CPC H02J 7/0004; H02J 7/0029; H02J 2007/0039; H01R 31/065; H02J 2007/0001; H01R 31/005

(57) ABSTRACT

A power feeding device coupled to a power receiving device via a USB cable having an authentication chip includes: a communication circuit communicating with the power receiving device; an authentication circuit executing an authentication process with the authentication chip; a power supply circuit supplying power to a power supply line in the USB cable; and a control circuit controlling the power supply circuit based on the authentication process and power supply information of the power feeding device from the communication circuit. When the authentication process between the authentication chip and the authentication circuit succeeds, the control circuit instructs to supply requested voltage and current to the power supply line. When the authentication process between the authentication chip and the authentication circuit fails, the control circuit instructs to supply to the power supply line the requested voltage and a restricted current that restricts the requested current.

### CROSS-REFERENCE TO RELATED APPLICATIONS

The disclosure of Japanese Patent Application No. 2016-242053 filed on Dec. 14, 2016 including the specification, drawings and abstract is incorporated herein by reference in its entirety.

### BACKGROUND

The disclosure relates to a power feeding device for supplying an output voltage to a USB (Universal Serial Bus) device.

A configuration (also referred to as USB power feeding) of supplying power to a USB device via a USB connector has been known from the past (Japanese Unexamined Patent Application Publication No. 2012-123673).

### SUMMARY

On the other hand, an output voltage supplied to a USB device in the related art was a fixed voltage (as an example, 5V).

However, the number of devices having USB connectors has increased in recent years, and a configuration of enabling USB power feeding to each device has been expected.

In this respect, since the power required for each device is different, the output voltage on the power feeding side needs to be not fixed but variable. Thus, it is necessary to ensure safety against power feeding at high voltage.

On the other hand, not only a method in which the power feeding device side and the USB device are directly coupled to each other, but also a power feeding method in which the output voltage is supplied to the USB device via a USB cable has been adopted, and the USB cable ensuring safety is desirably used.

The disclosure is to solve the above-described problems, and an object thereof is to provide a power feeding device, a power feeding system, and a control method of the power feeding device capable of supplying power at high voltage while ensuring safety.

The other objects and novel features will become apparent from the description of the specification and the accompanying drawings.

According to one embodiment, a power feeding device that is coupled to a power receiving device via a USB cable having a cable authentication chip includes: a communication circuit that communicates with the power receiving device using a communication line in the USB cable; an authentication circuit that executes an authentication process with the cable authentication chip via the communication line; a power supply circuit that supplies power to a power supply line in the USB cable; and a power supply control circuit that controls the power supply circuit on the basis of the result of the authentication process with the cable authentication chip and power supply information of the power feeding device received via the communication circuit. When the authentication process between the USB cable authentication chip and the authentication circuit succeeds, the power supply control circuit instructs to supply to the power supply line a voltage and a current requested by the power supply information. When the authentication process between the USE cable authentication chip and the authentication circuit fails, the power supply control circuit instructs to supply to the power supply line the voltage requested by the power supply information and a restricted current that restricts the current requested by the power supply information.

According to one embodiment, the power feeding device can supply power at high voltage while ensuring safety.

### BRIEF DESCRIPTION OF THE DRAWINGS

FIG. 1 is a diagram for explaining a configuration of a power feeding system 1 on the basis of a first embodiment;

FIG. 2 is a diagram for explaining functional blocks of a controller 14 on the basis of the first embodiment;

FIG. 3 is a power supply control sequence diagram in the power feeding system 1 on the basis of the first embodiment; and

FIG. 4 is another power supply control sequence diagram in the power feeding system 1 on the basis of the first embodiment.

### DETAILED DESCRIPTION

Embodiments will be described in detail with reference to the drawings. It should be noted that the same or corresponding parts are followed by the same reference numerals in the drawings, and the explanation thereof will not be repeated.

### First Embodiment

### <A. Entire Configuration>

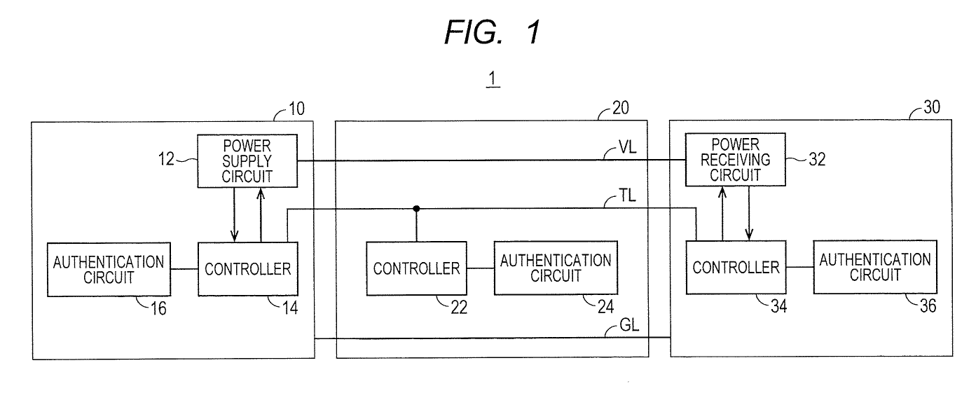

FIG. 1 is a diagram for explaining a configuration of a power feeding system 1 on the basis of a first embodiment.

With reference to FIG. 1, the power feeding system 1 includes a power feeding device 10, a USB cable 20, and a power receiving device 30.

The USB cable 20 includes a power supply line VL, a communication line TL, a ground line GL, a controller 22, and an authentication circuit (authentication chip) 24.

The power feeding device 10 includes a power supply circuit 12, a controller 14, and an authentication circuit (authentication chip) 16.

The power receiving device 30 includes a power receiving circuit 32, a controller 34, and an authentication circuit (authentication chip) 36.

The power supply circuit 12 is coupled to the power supply line VL.

The power supply circuit 12 is a power supply circuit that can variably adjust the voltage and the current level supplied to the outside by receiving an input of an alternating voltage (AC) or a direct current voltage (DC) as a power supply input. As an example, the voltage level can be adjusted in the range of 5V to 20V. Further, as an example, the current level can be adjusted in the range of 1 A to 3 A.

The controller 14 is coupled to the communication line TL. The controller 14 executes data communications with the power receiving device 30 via the communication line TL. The controller 14 receives power supply information related to the voltage and the current required by the power receiving device 30 from the power receiving device 30 in accordance with the data communications.

Further, the controller 14 obtains authentication data for executing an authentication process from the USB cable 20 and the power receiving device 30 via the communication line TL. The controller 14 outputs the authentication data obtained via the communication line TL to the authentication circuit 16.

The authentication circuit 16 executes the authentication process by receiving the authentication data output from the controller 14. The authentication circuit 16 outputs the authentication result to the controller 14. The authentication circuit 16 outputs authentication OK to the controller 14 when the authentication succeeds. On the other hand, the authentication circuit 16 outputs authentication NG to the controller 14 when the authentication fails.

In the example, the authentication circuit 16 executes the authentication process with the power receiving device 30 and the USB cable 20.

The controller 14 controls the power supply circuit 12 on the basis of the authentication result of the authentication process executed with the USB cable 20 and the power receiving device 30 and the power supply information received from the power receiving device 30, and instructs the power supply circuit 12 to set the output voltage and the output current supplied from the power supply line VL.

The controller 22 is coupled to the communication line TL. Further, the controller 22 is also coupled to the authentication circuit 24. The controller 22 accepts a request for authentication data from the controller 14 via the communication line TL. The controller 22 obtains the authentication data from the authentication circuit 24 in accordance with the request from the controller 14. Then, the controller 22 transmits the authentication data of the USB cable 20 to the controller 14 via the communication line TL.

The power receiving circuit 32 is coupled to the power supply line VL.

The power receiving circuit 32 supplies the necessary voltage and current to each unit in accordance with an input of the voltage and current supplied via the power supply line VL.

The controller 34 is coupled to the communication line TL. Further, the controller 34 is also coupled to the authentication circuit 36. The controller 34 accepts a request for authentication data from the controller 14 via the communication line TL. The controller 34 obtains the authentication data from the authentication circuit 36 in accordance with the request from the controller 14. Then, the controller 34 transmits the authentication data of the power receiving device 30 to the controller 14 via the communication line TL.

Further, when the authentication with the power feeding device 10 succeeds, the controller 34 transmits the power supply information related to the voltage and current necessary for the power receiving device 30 via the communication line TL.

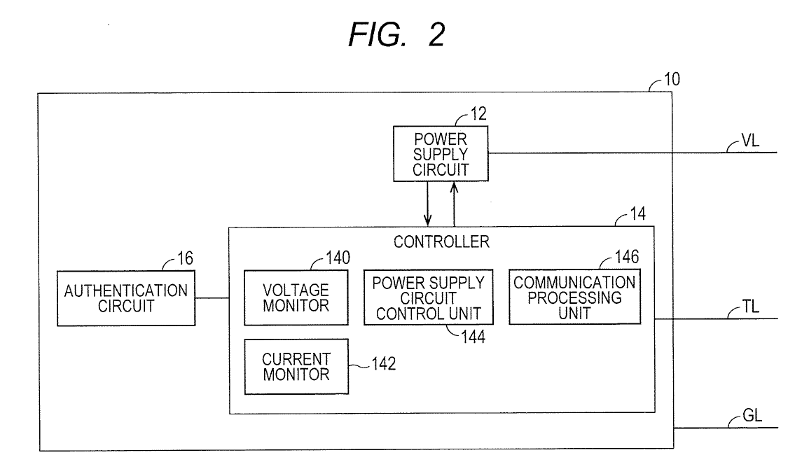

FIG. 2 is a diagram for explaining functional blocks of the controller 14 on the basis of the first embodiment.

With reference to FIG. 2, the controller 14 includes a voltage monitor 140, a current monitor 142, a power supply circuit control unit 144, and a communication processing unit 146.

The voltage monitor 140 monitors the voltage value supplied from the power supply circuit 12 via the power supply line VL.

The current monitor 142 monitors the current value supplied from the power supply circuit 12 via the power supply line VL.

The power supply circuit control unit 144 accepts inputs of the voltage value and the current value from the voltage monitor 140 and the current monitor 142.

The power supply circuit control unit 144 controls the power supply circuit 12 on the basis of the power supply information received from the power receiving device 30, and adjusts the output voltage and the output current supplied from the power supply line VL to the power supply circuit 12.

The communication processing unit 146 executes data communications with the controller 22 of the USB cable 20 via the communication line TL. Further, the communication processing unit 146 executes data communications with the controller 34 of the power receiving device 30 via the communication line TL. Further, the communication processing unit 146 is coupled to the authentication circuit 16, and outputs the authentication data to the authentication circuit 16.

### <B. Power Supply Control Sequence>

<b1. Authentication Process with Power Receiving Device 30 and USB Cable 20 (Part 1)>

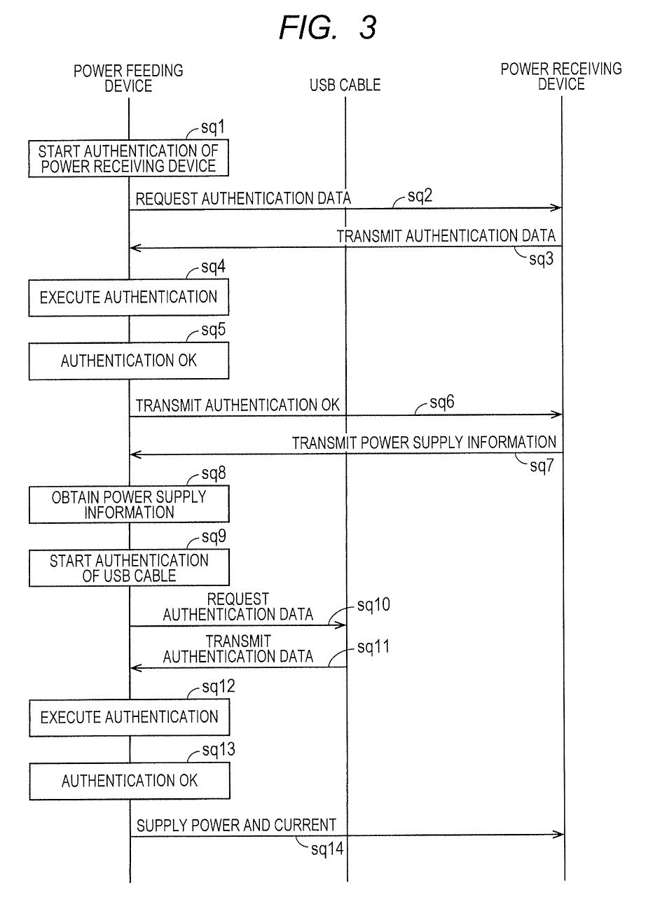

FIG. 3 is a power supply control sequence diagram in the power feeding system 1 on the basis of the first embodiment.

With reference to FIG. 3, the power feeding device 10 starts an authentication process with the power receiving device 30 (Sequence sq1). The power feeding device 10 starts the authentication process when detecting the connection of the power receiving device 30 via the USB cable 20.

Next, the power feeding device 10 requests the power receiving device 30 to transmit the authentication data (Sequence sq2). Specifically, the communication processing unit 146 requests the power receiving device 30 to transmit the authentication data via the communication line TL.

The power receiving device 30 transmits the authentication data to the power feeding device 10 (Sequence sq3). Specifically, the controller 34 of the power receiving device 30 accepts the request for the authentication data via the communication line TL. The controller 34 requests the authentication circuit 36 to transmit the authentication data. The authentication circuit 36 outputs the authentication data to the controller 34. The controller 34 transmits the authentication data output from the authentication circuit 36 to the power receiving device 30 via the communication line TL.

The power feeding device 10 executes the authentication process (Sequence sq4). The communication processing unit 146 receives the authentication data via the communication line TL. Then, the communication processing unit 146 outputs the received authentication data to the authentication circuit 16. The authentication circuit 16 executes the authentication process on the basis of the authentication data output from the communication processing unit 146.

Specifically, it is determined whether or not the authentication data preliminarily held by the authentication circuit 16 matches the authentication data output from the communication processing unit 146.

The power feeding device 10 determines that the authentication is OK (Sequence sq5). When it is determined that the authentication data matches another, the authentication circuit 16 determines that the authentication is OK. Then, the authentication circuit 16 outputs a notification that the authentication is OK to the communication processing unit 146.

Next, the power feeding device 10 transmits the authentication OK (Sequence sq6). The communication processing unit 146 transmits the notification of the authentication OK output from the authentication circuit 16 to the power receiving device 30 via the communication line TL.

Next, the power receiving device 30 receives the transmission of the authentication OK from the power feeding device 10, and transmits the power supply information (Sequence sq7). The controller 34 accepts the notification of the authentication OK received via the communication line TL. The controller 34 transmits the power supply information related to the voltage and current requested by the power receiving circuit 32 via the communication line TL in accordance with the notification of the authentication OK.

The power feeding device 10 obtains the power supply information (Sequence sq8). The communication processing unit 146 obtains the power supply information via the communication line TL. The communication processing unit 146 outputs the power supply information to the power supply circuit control unit 144.

Next, the power feeding device 10 starts the authentication process with the USB cable 20 (Sequence sq9).

Next, the power feeding device 10 requests the USB cable to transmit the authentication data (Sequence sq10). Specifically, the communication processing unit 146 requests the USB cable 20 to transmit the authentication data via the communication line TL.

The USB cable 20 transmits the authentication data to the power feeding device 10 (Sequence sq11). Specifically, the controller 22 of the USB cable 20 accepts the request for the authentication data via the communication line TL. The controller 22 requests the authentication circuit 24 to transmit the authentication data. The authentication circuit 24 outputs the authentication data to the controller 22. The controller 22 transmits the authentication data output from the authentication circuit 24 to the power receiving device 30 via the communication line TL.

The power feeding device 10 executes the authentication process (Sequence sq12). The communication processing unit 146 receives the authentication data via the communication line TL. Then, the communication processing unit 146 outputs the received authentication data to the authentication circuit 16. The authentication circuit 16 executes the authentication process on the basis of the authentication data output from the communication processing unit 146.

Specifically, it is determined whether or not the authentication data preliminarily held by the authentication circuit 16 matches the authentication data output from the communication processing unit 146.

The power feeding device 10 determines that the authentication is OK (Sequence sq13). When it is determined that the authentication data matches another, the authentication circuit 16 determines that the authentication is OK. Then, the authentication circuit 16 outputs a notification that the authentication is OK to the communication processing unit 146. The communication processing unit 146 instructs the power supply circuit control unit 144 to supply power in accordance with the notification of the authentication OK output from the authentication circuit 16.

Next, the power feeding device 10 supplies the voltage and current to the power receiving device 30 (Sequence sq14). The power supply circuit control unit 144 instructs the power supply circuit 12 to output the requested voltage and current on the basis of the power supply information obtained in accordance with the instruction. Accordingly, the voltage and current requested from the power supply circuit 12 via the power supply line VL are supplied to the power receiving device 30.

Next, a process in the case where the authentication process with the USB cable 20 is authentication NG will be described.

<b2. Authentication Process with Power Receiving Device 30 and USB Cable 20 (Part 2)>

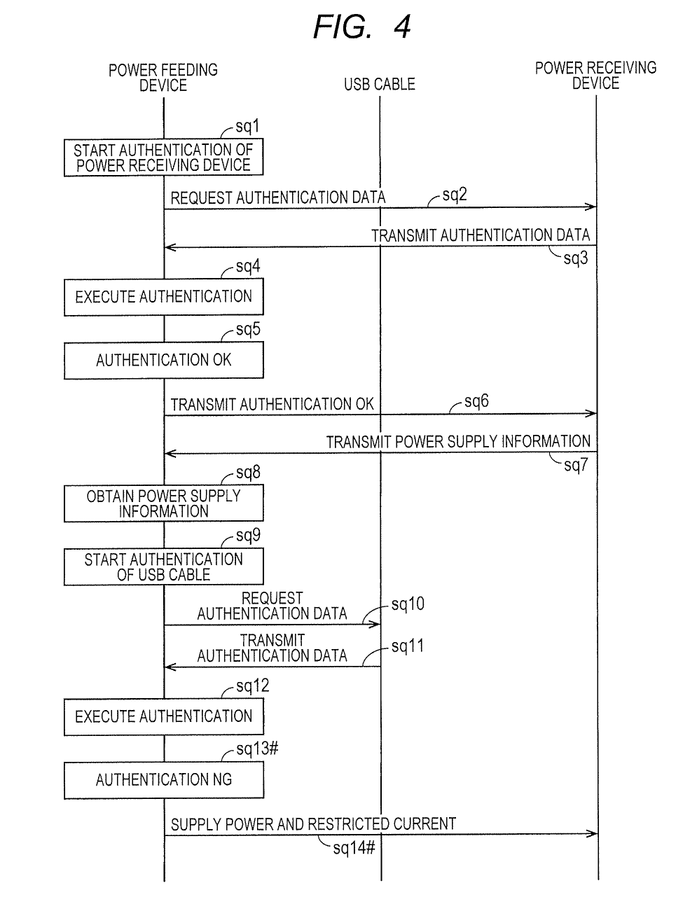

FIG. 4 is another power supply control sequence diagram in the power feeding system 1 on the basis of the first embodiment.

With reference to FIG. 4, FIG. 4 is different from the sequence diagram of FIG. 3 in that the authentication process with the USB cable 20 is authentication NG (Sequence sq13#). When it is determined that the authentication data does not match another, the authentication circuit 16 determines that the authentication is NG. Then, the authentication circuit 16 outputs a notification that the authentication is NG to the communication processing unit 146. The communication processing unit 146 instructs the power supply circuit control unit 144 to restrict the power supply in accordance with the notification of the authentication NG output from the authentication circuit 16.

Next, the power feeding device 10 supplies the voltage and restricted current to the power receiving device 30 (Sequence sq14#). The power supply circuit control unit 144 instructs the power supply circuit 12 to output the requested voltage and restricted current on the basis of the power supply information obtained in accordance with the instruction. Accordingly, the requested voltage and restricted current are supplied from the power supply circuit 12 to the power receiving device 30 via the power supply line VL. As one example, the restricted current is restricted to about 1 A.

Namely, when the authentication process with the USB cable 20 is authentication NG, the power supply is restricted in the example.

Specifically, the power supply circuit 12 outputs the requested voltage to the power receiving device 30, but supplies the restricted current to the power receiving device 30.

Accordingly, in the case of the power feeding method of supplying the output voltage to the USB device via the USE cable, when using the USB cable with the authentication unsuccessful, the power is supplied in the state where the current is restricted although the voltage is maintained. Accordingly, it is possible to ensure safety in the case of using the USB cable with the authentication unsuccessful.

In the case of the example, the authentication process with the power receiving device 30 succeeds. Thus, the example is a method in which instead of completely shutting off the power supply, the amount of current is restricted in consideration of safety so as to lower the supplied power while ensuring the voltage at which the power receiving device 30 can be operated.

Accordingly, it is possible to realize a power feeding device capable of feeding with high voltage while ensuring the safety of the USB cable.

### Second Embodiment

In a second embodiment, a process after power feeding from the power feeding device 10 to the power receiving device 30 is started will be described.

The power supply circuit 12 is set so that the requested voltage and restricted current flow to the power receiving device 30 via the power supply line VL.

However, when the state (mode) or the like of the power receiving device 30 coupled via the power supply line VL is changed, there is a possibility that a current equal to or higher than the restricted current flows to the power supply line VL.

In the second embodiment, a method of ensuring safety even in this case will be described.

Specifically, the current monitor 142 monitors the current value supplied to the power supply line VL.

The power supply circuit control unit 144 determines whether or not a current exceeding the restricted current flows in accordance with the current value detected by the current monitor 142 and supplied to the power supply line VL.

When it is determined that a current exceeding the restricted current flows to the power supply line VL, the power supply circuit control unit 144 stops the power supply from the power supply circuit 12 to the power supply line VL.

According to this method, it is possible to suppress a current equal to or higher than the restricted current from flowing to the USB cable with the authentication unsuccessful, and to ensure the safety of the USB cable by lowering the supplied power.

### First Modified Example

In the above description of the second embodiment, the power supply circuit control unit 144 is configured to stop the power supply circuit 12 when it is determined that a current exceeding the restricted current flows to the power supply line VL. However, a method in which the power supply circuit control unit 144 does not stop the power supply circuit 12 will be described in the first modified example.

Specifically, when it is determined that a current exceeding the restricted current flows to the power supply line VL, the power supply circuit control unit 144 restricts the power supply circuit 12 so that the current value does not exceed the restricted current. Accordingly, a voltage drop occurs, but the operation of the power receiving device 30 can be continued if the voltage level falls within the operation range because the power supply circuit 12 is not stopped.

Further, in the case where a function such as a power saving mode is provided on the power receiving device 30 side, it is also possible to prompt switching to the power saving mode by lowering the voltage level.

### Second Modified Example

In the first modified example, the method of restricting the current value so as not to exceed the restricted current has been described, but the restriction may be intermittently executed.

Specifically, when the current monitor 142 detects that a current equal to or higher than the set restricted current flows to the power supply line VL, the power supply circuit control unit 144 intermittently restricts the power supply circuit 12 so that the current value does not exceed the restricted current. Accordingly, a voltage drop intermittently occurs. The operation of the power receiving device 30 can be easily continued as compared to the case where the current is always restricted.

Further, in the case where a function such as a power saving mode is provided on the power receiving device 30 side, it is also possible to prompt switching to the power saving mode by confirming plural voltage drops on the power receiving device 30 side.

### <Another Mode>

In the above description, the power receiving device 30 is configured to accept the supply of the voltage and current from the power feeding device 10. However, the power receiving device 30 can be also configured to have the same functions of the power supply circuit 12 and the controller 14 as similar to the power feeding device 10. Namely, the power receiving device 30 also has a function as the power feeding device 10, and can be also configured to supply the power supply voltage to another USB device.

The disclosure has been concretely described above on the basis of the embodiments. However, it is obvious that the disclosure is not limited to the embodiments, and can be variously changed without departing from the gist thereof.

What is claimed is:

1. A power feeding device that is coupled to a power receiving device via a USB cable having a cable authentication chip, the power feeding device comprising:
a communication circuit that communicates with the power receiving device using a communication line in the USB cable;
an authentication circuit that executes an authentication process with the cable authentication chip via the communication line;
a power supply circuit that supplies power to a power supply line in the USB cable; and
a power supply control circuit that controls the power supply circuit on the basis of the result of the authentication process with the cable authentication chip and power supply information of the power feeding device received via the communication circuit,
wherein when the authentication process between the USB cable authentication chip and the authentication circuit succeeds, the power supply control circuit instructs to supply to the power supply line a voltage and a current requested by the power supply information, and
wherein when the authentication process between the USB cable authentication chip and the authentication circuit fails, the power supply control circuit instructs to supply to the power supply line the voltage requested by the power supply information and a restricted current that restricts the current requested by the power supply information.

2. The power feeding device according to claim 1,
wherein the authentication circuit executes the authentication process with an authentication chip of the power receiving device via the communication line.

3. The power feeding device according to claim 2,
wherein when the authentication process with the authentication chip of the power receiving device succeeds, the communication circuit receives the power supply information of the power feeding device.

4. The power feeding device according to claim 1,
wherein a current detection unit for detecting the amount of current supplied to the power supply line is further provided.

5. The power feeding device according to claim 4,
wherein the power supply control circuit instructs the power supply circuit to restrict the amount of current when the amount of restricted current is increased in accordance with the detection result of the current detection unit.

6. The power feeding device according to claim 5,
wherein the power supply control circuit instructs the power supply circuit to shut off the supply of the current when the amount of restricted current is increased in accordance with the detection result of the current detection unit.

7. The power feeding device according to claim 5,
wherein the power supply control circuit instructs the power supply circuit to intermittently restrict the amount of current when the amount of restricted current is increased in accordance with the detection result of the current detection unit.

8. A power feeding system comprising:
a USB cable having a cable authentication chip;
a power receiving device; and
a power feeding device that is coupled to the power receiving device via the USB cable,
wherein the power feeding device includes:
a communication circuit that communicates with the power receiving device using a communication line in the USB cable;
an authentication circuit that executes an authentication process with the cable authentication chip via the communication line;
a power supply circuit that supplies power to a power supply line in the USB cable; and
a power supply control circuit that controls the power supply circuit on the basis of the result of the authentication process with the cable authentication chip and power supply information of the power feeding device received via the communication circuit,
wherein when the authentication process between the USB cable authentication chip and the authentication circuit succeeds, the power supply control circuit instructs to supply to the power supply line a voltage and a current requested by the power supply information, and
wherein when the authentication process between the USB cable authentication chip and the authentication circuit fails, the power supply control circuit instructs to supply to the power supply line the voltage requested by the power supply information and a restricted current that restricts the current requested by the power supply information.

9. The power feeding system according to claim 8,
wherein the power receiving device has an authentication chip, and
wherein the authentication circuit executes the authentication process with the authentication chip of the power receiving device via the communication line.

10. A control method of a power feeding device that is coupled to a power receiving device via a USB cable having a cable authentication chip, the method comprising the steps of:
communicating with the power receiving device using a communication line in the USB cable;
executing an authentication process with the cable authentication chip via the communication line;
supplying power to a power supply line in the USB cable; and
controlling the power supply circuit on the basis of the result of the authentication process with the cable authentication chip and power supply information of the power feeding device received via the communication circuit,
wherein when the authentication process between the USB cable authentication chip and the authentication circuit succeeds, the step of controlling the power supply circuit includes a step of instructing to supply to the power supply line a voltage and a current requested by the power supply information, and
wherein when the authentication process between the USB cable authentication chip and the authentication circuit fails, the step of controlling the power supply circuit includes a step of instructing to supply to the power supply line the voltage requested by the power supply information and a restricted current that restricts the current requested by the power supply information.
